(19) United States
(12) Patent Application Publication
(10) Pub. No.: US 2010/0095091 A1
(43) Pub. Date: Apr. 15, 2010

(54) Processor, Method and Computer Program

(75) Inventor: Kazunori Asanaka, Yokohama (JP)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 12/529,184

(22) PCT Filed: Mar. 20, 2008
(86) PCT No.: PCT/EP08/53384

§ 371 Date: Oct. 5, 2009

Related U.S. Application Data
(60) Provisional application No. 60/939,561, filed on May 22, 2007.

(30) Foreign Application Priority Data
Mar. 26, 2007 (JP) 2007-080000

(51) Int. Cl. G06F 9/30; G06F 9/38

(52) U.S. Cl. 712/208; 712/239; 712/E09.016; 712/E09.045

(57) ABSTRACT

To accelerate processing speed of a processor while keeping increased complexity in the processor's circuitry to a minimum. A processor is offered, comprising a decoder which sequentially acquires and decodes an instruction from a program, including an instruction of a first type and a second type, which are classified according to a property of data upon which the instruction is to operate; a first operation unit which sequentially receives from the decoder, and executes, the instruction of the first type; an operand processing circuit which substitutes a variable value, which is set into a register that is associated with the first operation unit, and which is included within an operand of the instruction of the second type, with a constant; a buffer which queues the instruction of the second type that has been decoded by the decoder, and the operand thereof has been substituted by the operand processing circuit; and a second operation unit which sequentially receives from the buffer, and executes, the instruction of the second type. Methods and computer program for implementing the methods are also disclosed.

### TECHNICAL FIELD

The present invention relates to a processor for a program that includes two types of instructions, which are classified according to a property of data upon which the instruction is to operate. The present invention also relates to methods for operating the processor, and computer program for performing the methods.

### BACKGROUND

A pipeline process is an established technique of increasing the speed of a processor. A pipelined processor, that is, a processor capable of executing a pipeline process, such as a CPU, a digital signal processor (DSP), or an application specific processor (ASP), executes the following process sequence, with the proviso that the number of a given process depends upon the particular processor implementation:

(1) Decode an instruction;

(2) Fetch a source operand from either a register or memory;

(3) Execute an operation; and

(4) Write a result of the operation to either the register or memory.

The pipelined processor may experience a pipeline stall for a reason such as the following:

(1) A collision or lack of a resource, for example, a memory port or an operation resource; or

(2) Failure to completely prepare dependent data, for example, a source operand, an address, or a flag, arising from pipeline latency. Out-of-Order Execution, wherein an instruction sequence is reordered and executed, is a known technology for avoiding pipeline stall and achieving further processor acceleration; see cited reference 1, below, for an example.

Another known technology for increasing processor speed separates a branch instruction and an instruction that computes a branch condition, which are collectively referred to as branch control code, from other regular instructions; see cited reference 2, below, for an example.

Cited Reference 1: Japanese Patent Laid Open No. 2001-236222

Cited Reference 2: Japanese Patent Laid Open No. 2004-171248

Performing out-of-order execution requires that the processor verify a dependent relationship between instructions, thus complicating the processor's circuit configuration. Consequently, problems arise such as an increase in a number of transistors on a processor, a commensurate increase in power consumption, a commensurate increase in a chip's surface area, and an increase in cost. The problems are of particular concern for a processor intended for use in a mobile electronic device, which demands a miniaturized device size and reduced power consumption, among other characteristics. When a loop is executed, the technology recited in the cited reference 2 cannot use a variable, which is used in making a branch condition determination, in the loop. A source code depicted in FIG. 1(a) of the cited reference 2 uses a variable “i” as an index of a variable “z” and a variable “b” in a “FOR” loop. An assembly code depicted in FIG. 1(b) of the cited reference 2, however, separates an instruction for computing the variable “i”, precluding using a register (C6) of the variable “i” in the execution of the loop. Consequently, there is an increase in the number of instructions, and a slowdown in processor speed, together with a need to set aside another register for use by the branch control code.

The present invention was devised with such a circumstance in mind, and has as its feature to offer a technology that accelerates the processor's processing speed while keeping complexity of circuit configuration under control.

### SUMMARY

A processor is offered according to the present invention to solve the problems, comprising a decoder that sequentially acquires and decodes an instruction from a program, including an instruction of a first type and a second type, which are classified according to a property of data upon which the instruction is to operate, a first operation unit that sequentially receives from the decoder, and executes, an instruction of the first type, an operand processing circuit that substitutes a variable value, which is loaded into a register that is associated with the first operation unit, and which is included within an operand of the instruction of the second type, with a constant, a buffer that queues the instruction of the second type that has been decoded by the decoder, and the operand thereof has been converted by the operand processing circuit, and a second operation unit that sequentially receives from the buffer, and executes, the instruction of the second type.

According to another embodiment, a processor is offered comprising a plurality of subprocessors, in turn comprising a decoder that sequentially acquires and decodes an instruction from a program, including an instruction of a first type and a second type, which are classified according to a property of data upon which the instruction is to operate, a first operation unit that sequentially receives from the decoder, and executes, an instruction of the first type, an operand processing circuit that substitutes a variable value, which is loaded into a register that is associated with the first operation unit, and which is included within an operand of the instruction of the second type, with a constant, a buffer that queues the instruction of the second type that has been decoded by the decoder, and the operand thereof has been converted by the operand processing circuit, and a register file that stores a register value according to the instruction of the second type, the processor further comprising a plurality of operation units that executes an operation according to the instruction of the second type, and a control circuit that sequentially acquires the instruction of the second type in parallel from each respective buffer of the plurality of subprocessors, and supplies the acquired instruction to the operation unit that is selected, from the plurality of operation units, in accordance with a type of operation that is executed by the instruction thus acquired.

Other characteristics of the present invention will become apparent from the recitation involving the attached drawings and the following exemplary embodiments of the present invention.

According to an aspect of the invention there is provided a method for operating a processor. According to one embodiment, the method comprises sequentially acquiring and decoding instructions from a program by a decoder, including an instruction of a first type and an instruction of a second type, which are classified according to a property of data upon which the instruction is to operate; sequentially receiving from the decoder, and executing the instruction of the first type by a first operation unit; substituting a variable value with a constant by an operand processing circuit, which variable value is set into a register that is associated with the first operation unit, and which is included within an operand of the instruction of the second type; queuing in a buffer the instruction of the second type that has been decoded by the decoder, and the operand thereof has been substituted by the operand processing circuit; and sequentially receiving from the buffer, and executing the instruction of the second type by a second operation unit.

According to another embodiment, the method is for operating a processor comprising a plurality of subprocessors, a plurality of operation units and a control circuit, the method comprising sequentially acquiring and decoding instructions from a program by a decoder of at least one of the subprocessors, the instructions including an instruction of a first type and an instruction of a second type which are classified according to a property of data upon which the instruction is to operate; sequentially receiving from the decoder, and executing the instruction of the first type by a first operation unit of one of the subprocessors; substituting a variable value with a constant, which variable value is set into a register that is associated with the first operation unit, and which is included within an operand of the instruction of the second type by an operand processing circuit; queuing in a buffer the instruction of the second type that has been decoded by the decoder, and the operand thereof has been substituted by the operand processing circuit; and storing by a register file a register value associated with the instruction of the second type; sequentially acquiring the instruction of the second type in parallel from each respective buffer of the plurality of subprocessors, and supplying the acquired instruction to an operation unit that is selected, from a plurality of operation units, in accordance with a type of operation that is executed by the acquired instruction by a control circuit; and executing the operation associated with the instruction of the second type by the selected operation unit of the plurality of operation units.

According to a further aspect of the invention, there is provided a computer program comprising instructions, which when executed by a processor causes the processor to perform the method according to any of the embodiments. The above-described configurations allow increased processor processing speed while keeping increased complexity of circuit configuration under control.

### BRIEF DESCRIPTION OF DRAWINGS

FIG. 1 depicts a program written in the C programming language, for the purpose of illustrating the basic concept of an embodiment.

FIG. 2 depicts an example of an assembly code that is obtained by compiling the program depicted in FIG. 1.

FIG. 3 is a block diagram depicting an example of a configuration of a processor according to an embodiment.

FIG. 4 depicts an example of an instruction set of the processor according an embodiment.

FIG. 5 depicts an example of registers that the processor comprises according to an embodiment.

FIG. 6 describes an operand notation according to an embodiment.

FIG. 7 depicts an example of a pipeline and a bypass circuit of an integer unit of the processor according to an embodiment.

FIG. 8 depicts an example of a pipeline and a bypass circuit of a floating-point unit of the processor according to an embodiment.

FIG. 9 depicts an example of a configuration that controls a stall within the processor according to an embodiment.

FIG. 10 depicts an example of a configuration that adds a speculative execution function to the processor according to an embodiment.

FIGS. 11A and 11B depict a flow of data between each respective integer unit or floating-point unit, and the memory interface, of the RISC processor or the CISC processor.

FIG. 12 is a block diagram depicting an example configuration of a processor according to an embodiment.

FIG. 13 is a flow chart illustrating a method according to an embodiment.

FIG. 14 is a flow chart illustrating a method according to another embodiment.

### DETAILED DESCRIPTION

Following is a description of embodiments of the present invention, with reference to the attached drawings. Each embodiment described hereinafter will aid in understanding a variety of concepts from the generic to the more specific. The technical scope of the present invention is defined by claims, and is not limited by the individual embodiments described hereinafter. In addition, all combinations of the features described in the embodiments are not necessarily required for the present invention in all instances.

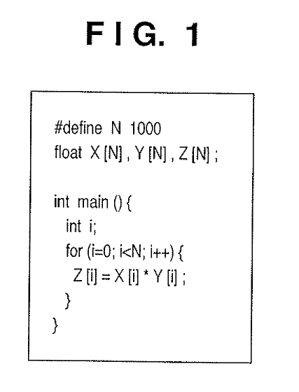

FIG. 1 describes a basic concept of a first embodiment, with reference to a program written in the C programming language.

An instruction that the processor executes according to the embodiment includes an objective and a non-objective instruction, which are classified according to a property of data upon which the instruction is to operate.

An objective instruction treats either an I/O data that is an object of the program, as well as an interim data thereof, i.e., a data that is being operated on, as a data to be operated on.

A non-objective instruction treats a data other than the I/O data that is an object of the program or the interim data thereof as a data to be operated on.

In FIG. 1, instructions such as a multiplication instruction “*” in “X[i]*Y[i]” or an assignment instruction “=” that assigns the multiplication result to “Z[i]” are objective instructions. Instructions such as a “++” instruction that increments the variable “i”, in order to control a “for” loop, or a “<” instruction that compares the variable “i” with a constant “N” in order to determine when the loop terminates, are non-objective instructions.

According to the embodiment, data that is to be operated on by an objective instruction is referred to as “objective data,” and data that is to be operated on by a non-objective instruction is referred to as “non-objective data”.

Note that a given operator, such as “+”, can be treated as either an objective or a non-objective instruction, depending on the data to be operated on.

In FIG. 1, “X[i]”, “Y[i]”, and “Z[i]” are objective data, and “N” and “i” are non-objective data.

In general, objective data is a physical quantity that is depicted in terms of a unit of measurement, such as meters, seconds, or meters/second, and is treated as a floating-point value within a program. One reason is that a cellular phone processor would execute a program that computes such values as voltage or current, for example.

Non-objective data, by contrast, is a value that is put to such use as a variable that controls a loop or an index of an array, and as such, has no unit of measurement and is treated as an integer within a program.

Consequently, it is permissible to define that an objective instruction is an instruction that treats floating-point data to be operated on, and a non-objective instruction is an instruction that treats integer data to be operated on, according to one embodiment.

The basic concept of the first embodiment is that the processor separates the objective from the non-objective instructions, and executes them in parallel with one another. Consequently, the processor of the present invention comprises a floating-point arithmetic and logic unit, or ALU, for executing objective instructions, and an integer ALU, for executing non-objective instructions. Typically, executing an objective instruction requires more processor cycles than executing a non-objective instruction. Consequently, when the processor according to the present embodiment executes the program in FIG. 1, the process connected with the variable “i”, i.e., the execution of the non-objective instructions, terminates quickly, with expanding the program loop as follows:

$$\begin{matrix}Z [ 0 ] = {X [ 0 ]}^{*} Y [ 0 ] \\ Z [ 1 ] = {X [ 1 ]}^{*} Y [ 1 ] \\ Z [ 2 ] = {X [ 2 ]}^{*} Y [ 2 ] \\ Z [ 3 ] = {X [ 3 ]}^{*} Y [ 3 ] \\ … \\ … \\ … \\ ] Z [ 999 ] = {X [ 999 ]}^{*} Y [ 999 ]\end{matrix}$$

It would be possible for the floating-point ALU to execute the expanded operations in order, allowing faster completion of the operations than would be possible if the non-objective instructions were not separated out.

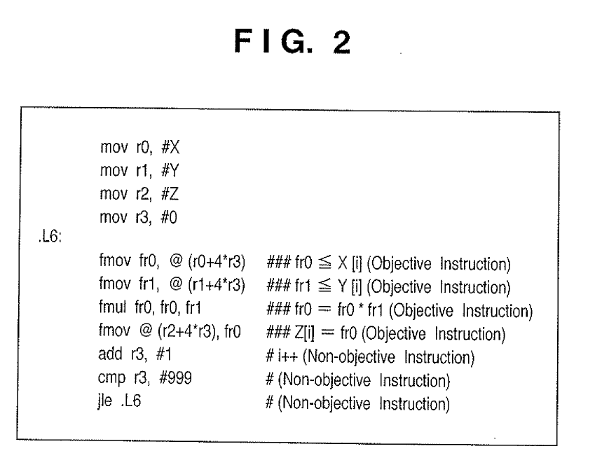

FIG. 2 depicts an example of an assembly code that is obtained by compiling the program depicted in FIG. 1. An important point to note is that the value of “i”, which controls the loop, i.e., the variable that is loaded into a register r3, is also used as the index of the arrays X, Y, and Z during the loop iterations.

Regarding the assembly code depicted in FIG. 2, simply separating the objective from the non-objective instructions is insufficient to allow the processor to execute a non-objective instruction that changes the register r3, to wit:

add r3, #1

ahead of objective instructions that use the register r3, to wit:

fmov fr0, @(r0+4*r3)

fmov fr1, @(r1+4*r3)

fmov @(r2+4*r3), fr0

If the instruction is executed out of sequence, the index values of X, Y, and Z, which depend on the execution of the non-objective instruction, will be changed, preventing them from pointing to the correct memory addresses.

While it is possible to configure the compiler that generates the assembly code not to use the same register for objective and non-objective instructions, such a measure is not taken according to the embodiment, because doing so would involve an increased number of instructions or required registers, as described in the section on “BACKGROUND”.

Accordingly, the processor according to the embodiment comprises a configuration described hereinafter.

Not all objective instructions are necessarily processed by the floating-point ALU. Nor are all non-objective instructions necessarily processed by the integer ALU. For example, a conditional branch instruction “jle”, which is a non-objective instruction, is processed by the instruction decoder, rather than the integer ALU.

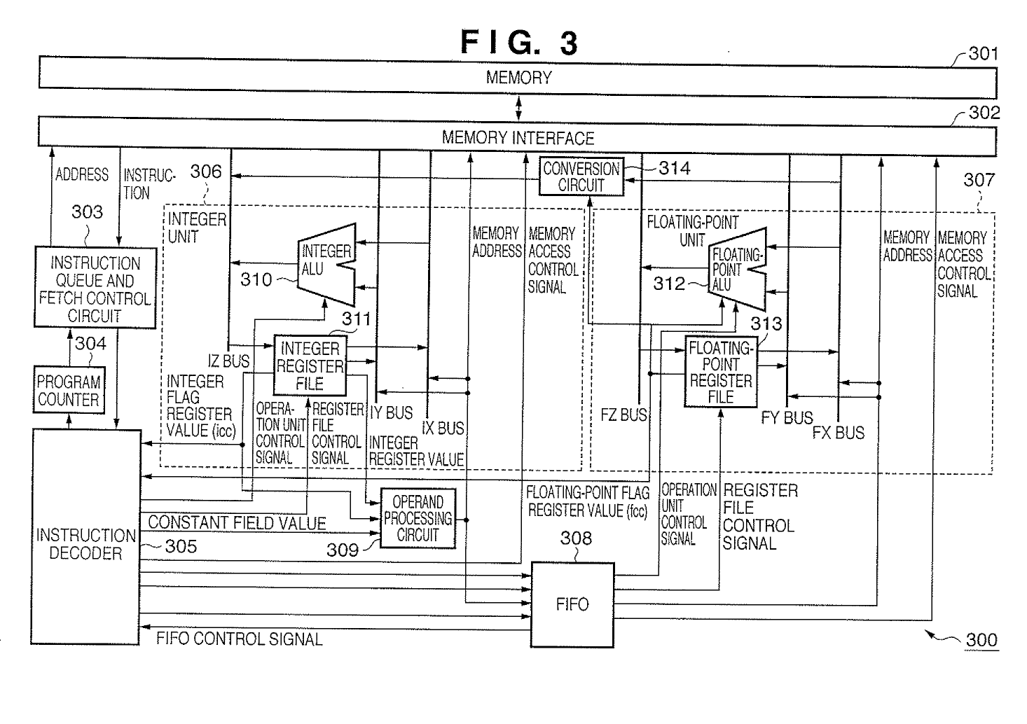

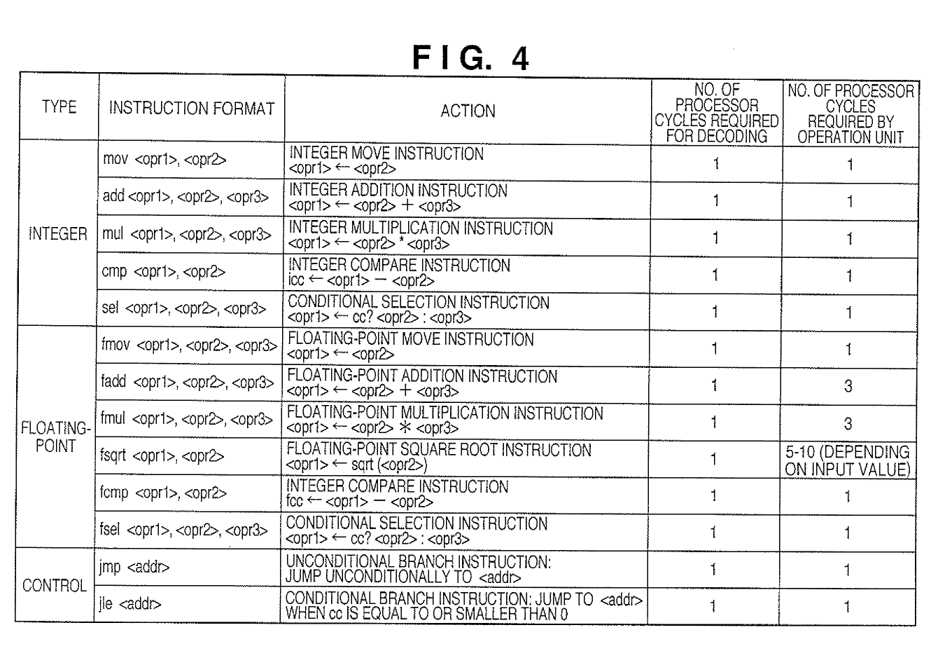

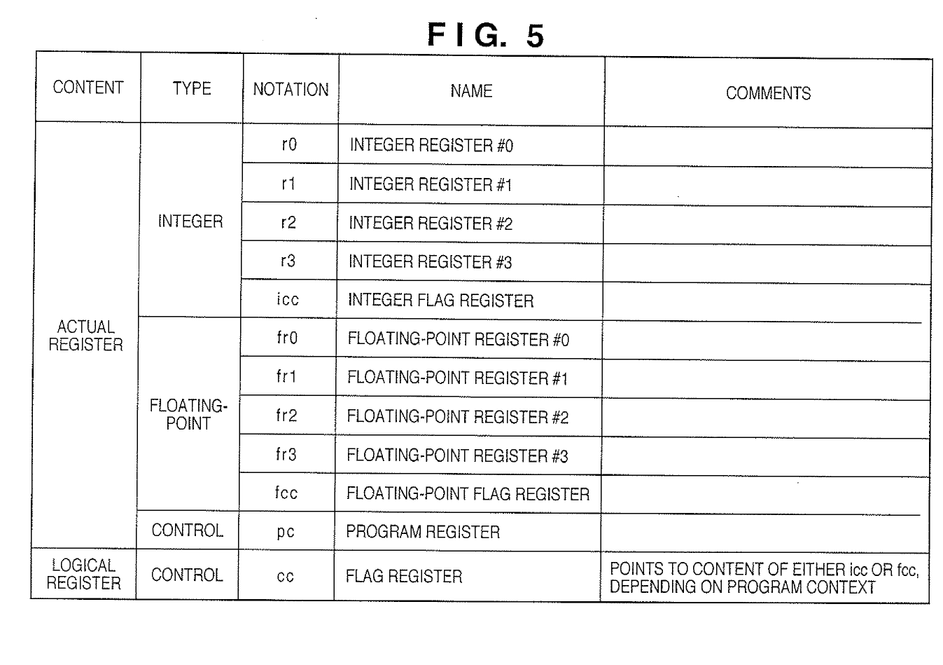

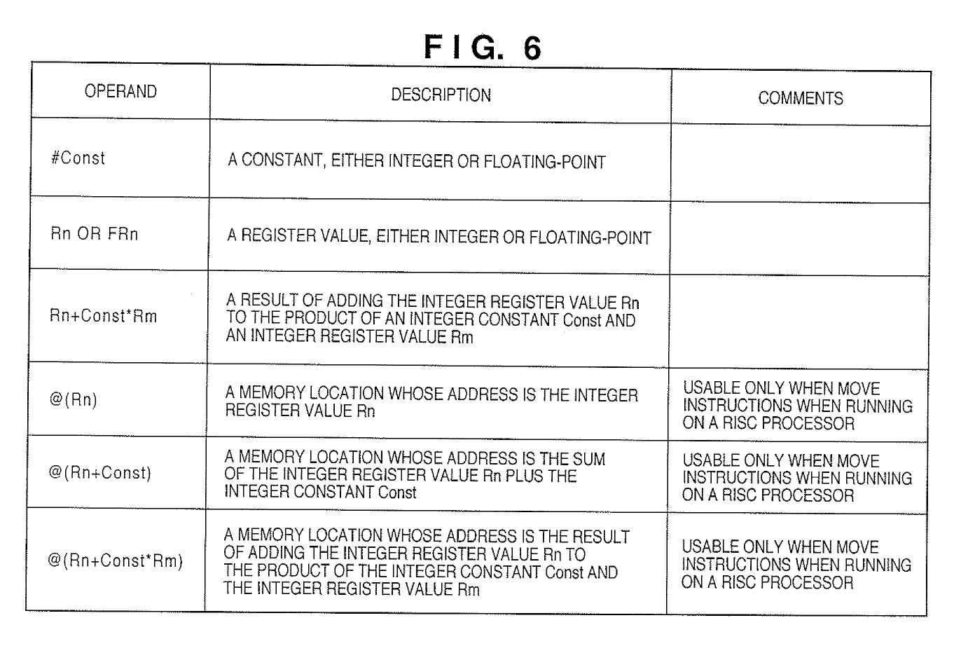

FIG. 3 is a block diagram depicting an example of a configuration of a processor 300, according to the first embodiment. FIG. 4 depicts an example of an instruction set of the processor 300. FIG. 5 depicts an example of registers that the processor 300 comprises. FIG. 6 describes an operand notation according to the embodiment. It is presumed that an integer instruction in FIG. 4 is a non-objective instruction, and a floating-point instruction is an objective instruction, according the embodiment. Accordingly, the integer data is the non-objective data, and the floating-point data is the objective data. The definition of the objective instruction and data, and the definition of the non-objective instruction and data, are not limited hereto, however. Rather, the definitions are as per the description in the “Basic Concept” section. A control instruction is processed by an instruction decoder 305, described hereinafter, despite being a non-objective instruction. When the control instruction uses a flag register cc in a branch, such as “jle” as depicted in FIG. 4, the value of the flag register is supplied to the instruction decoder 305 from either an integer register file 311 or a floating-point register file 313, as depicted in FIG. 3. The flag register cc is a logical flag register, as seen from the software, with a physical flag register value, either icc or fcc, chosen from either the integer register file 311 or the floating-point register file 313, depending on whether the instruction that is executed immediately prior to generating a flag is an integer or a floating-point operation.

The physical flag registers that are respectively held by an integer unit 306 and a floating-point unit 307 are for parallel execution of operations pertaining to the integer unit 306 and the floating-point unit 307. If only a single physical flag register is present, and is shared between the integer unit and the floating-point unit, a flag value that is generated by an objective instruction, the execution whereof is delayed due to queuing on the part of a FIFO 308, i.e., a buffer, will erase the flag value that was generated by a non-objective instruction.

In FIG. 3, the processor 300 comprises a memory 301, a memory interface (I/F) 302, an instruction queue and fetch control circuit 303, a program counter 304, the instruction decoder 305, the integer unit 306, the floating-point unit 307, the FIFO (First In, First Out) 308, an operand processing circuit 309, and a conversion circuit 314. It is unnecessary, however, for all blocks depicted in FIG. 3 to be formed into a single unit in the processor 300. It would be permissible for the memory 301 to be comprised on a separate chip from the processor 300, for example. It would be possible for the FIFO 308 to be implemented by a storage element such as a semiconductor memory.

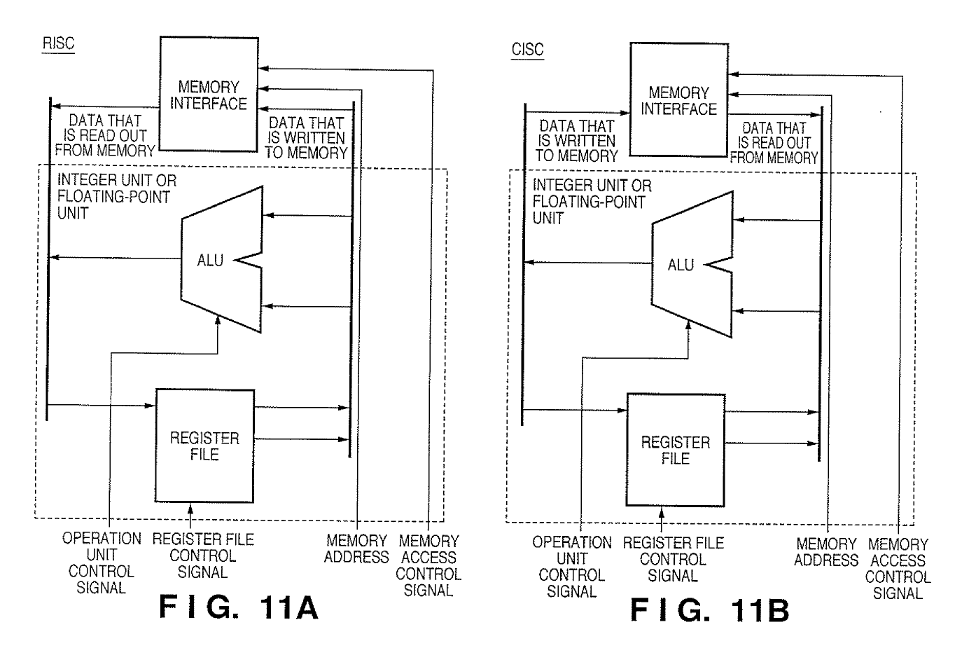

While it is presumed that the processor 300 is a RISC processor according to the embodiment, the concept according to the embodiment is also applicable to a CISC processor architecture. The RISC processor architecture referenced herein has the ALU and the memory interface connected in parallel, and can only perform one or the other of a memory access and a primary operation in a single instruction; refer to FIG. 11A for details. When applied to the CISC processor architecture, it is permissible for a single instruction to read out an input operand value from the memory, supply the value to the ALU, and write an operation result back to the memory; refer to FIG. 11B for details. While it is presumed that an operand that can be received by an integer ALU 310 and a floating-point ALU 312, described hereinafter, will be no more than two input operands, and no more than one output operand, the invention is not limited thereto.

The memory 301 stores the program that the processor 300 executes, as well as data that is processed by the program. Other blocks access the memory 301 via the memory interface 302.

The instruction queue and fetch control circuit 303 obtains and queues the instruction from the memory 301, according to the address to which the program counter 304 points.

The instruction decoder 305 obtains and decodes the instruction from the instruction queue and fetch control circuit 303 in the order that the instructions are queued, and determines whether the instruction is an objective or a non-objective instruction.

If the instruction is a non-objective instruction, the instruction decoder 305 generates a control signal that controls the integer unit 306. The control signal of the integer unit 306 includes an operation unit control signal, a register file control signal, and a memory access control signal. The operation unit control signal denotes the type of operation, such as addition or subtraction, which the integer ALU 310 will be made to execute. The register file control signal denotes which of the registers that are included in the integer register file 311 are targeted for access. The memory access control signal denotes a read/write control signal pertaining to the memory 301 that the integer unit 306 accesses. If the instruction is an objective instruction, the instruction decoder 305 generates a control signal that controls the floating-point unit 307, and queues it in the FIFO 308. If the FIFO 308 is full, the FIFO 308 notifies the instruction decoder 305 with a FIFO control signal, and the instruction decoder 305 interrupts processing until space opens in the FIFO 308. The control signal of the floating-point unit 307 includes an operation unit control signal, a register file control signal, and a memory access control signal. The operation unit control signal denotes the type of operation which the floating-point ALU 312 will be made to execute. The register file control signal denotes which of the registers that are included in the floating-point register file 313 are targeted for access. The memory access control signal denotes a read/write control signal pertaining to the memory 301 that the floating-point unit 307 accesses.

If a constant is included among the instruction operands, the instruction decoder 305 supplies the constant to the operand processing circuit 309.

Additionally, if an integer register is included among the operands of the instruction, the instruction decoder 305 generates the register file control signal that denotes the integer register, and supplies the register file control signal to the integer register file 311, thus supplying the value of the integer register to the operand processing circuit 309, even if the instruction is an objective instruction.

The operand processing circuit 309 processes the operand, the nature of the processing varying depending on whether or not the operand is a type that queries the memory, i.e., a type that is marked with an “@” in FIG. 6. The nature of the processing also varies with an objective versus a non-objective instruction. As per the foregoing, the constant that is included among the operands is supplied by the instruction decoder 305, and the value of the integer register is supplied by the integer register file 311.

If the operand is the type that queries the memory:

The operand processing circuit 309 performs an operation of an address of an operand. For example, if the operand is @(r0+4*r3), the value of the register r0 is 0×1000, and the value of the register r3 is 0×100, the operand processing circuit 309 calculates r0+4*r3, and obtains the address 0×1400.

If the instruction is a non-objective instruction, the operand processing circuit 309 supplies the address 0×1400 to the memory interface 302, which, in turn, either supplies the data at the address 0×1400 in the memory 301 to the integer ALU 310, via either an IX bus or an IY bus, or writes the results of the operation performed by the integer ALU 310 to the address 0×1400 in the memory 301, via an IZ bus.

If the instruction is an objective instruction, the operand processing circuit 309 converts the operand @(r0+4*r3) to a post-address operation operand @(0×1400), and supplies the operand to the FIFO 308. Consequently, the instruction

fmov fr0, @(r0+4*r3)

in FIG. 2 is converted into

fmov fr0, @(0×1400).

More precisely, the instruction decoder 305 decodes the instruction into the format of the control signal of the floating-point unit 307. Thus, the operand processing circuit 309 substitutes a constant for the variable value of the register related to the integer unit 306, such as r0 or r3. It would also be permissible to execute an operation between post-substitute constants, such as addition or multiplication.

Thus is resolved the dependent relationship with the register r3, which stores the variable “i” that controls the loop. The post-conversion non-objective instruction is queued in the FIFO 308, and execution commences once the floating-point unit 307 is ready. The memory interface 302 either reads the address 0×1400 in the memory 301, and writes the data to the floating-point register file 313, via an FZ bus, or writes the read-out data from the floating-point register file 313 to the address 0×1400 in the memory 301, via either an FX bus or an FY bus, all depending on the position of the operand that queries the memory. In the example, the operand @(0×1400) is the first input operand, and the data at the address 0×1400 in the memory 301 is written to the floating-point register file 313, via the FZ bus.

When applied to the CISC processor architecture, either the address 0×1400 in the memory 301 is read out, and the data written to the floating-point ALU 312, via the FZ bus, or the results of the operation performed by the floating-point ALU 312 are written to the memory, via the FZ bus. An instruction that possesses an operand that queries the memory on both input and output operands performs both read/write operations.

If the operand is the type that does not query the memory:

If the instruction is an objective instruction, an instruction other than fmov can only use a floating-point operand. Consequently, there is no need to resolve the dependent relationship between the floating-point unit 307 and the integer unit 306.

When converting integer data to floating-point data, or floating-point data to integer data, an integer register is included in the fmov operands as follows:

fmov fr0, r3 (convert integer data to floating-point data)

fmov r3, fr0 (convert floating-point data to integer data)

In the former instance, the operand processing circuit 309 obtains the register r3 value, which it supplies to the FIFO 308. The floating-point ALU 312 writes the register r3 value to the register fr0 in the floating-point register file 313. In the latter instance, the fmov instruction is processed by the conversion circuit 314, which converts a floating-point number to an integer, and writes the result of the conversion to the register r3 in the integer register file 311, by way of the IZ bus.

In either instance, a dependent relationship exists between the floating-point unit 307 and the integer unit 306. Accordingly, It is necessary to either interrupt processing until all data to be converted is ready, or resolve the dependent relationship by some other method, to be described hereinafter.

The integer unit 306 includes the integer ALU 310, the integer register file 311, and the IX bus, the IY bus, and the IZ bus. The integer ALU 310 executes non-objective instructions according to the operation unit control signal that is supplied by the instruction decoder 305. In such a circumstance, the input operand(s) is/are supplied via at least one of the IX bus and the IY bus, The IZ bus is notified of the output operand, and the result of the operation of the integer ALU 310 is supplied to the integer register file 311, according to the output operand. The operation result may also be supplied to the memory 301 when the invention is applied to the CISC processor architecture.

The floating-point unit 307 includes the floating-point ALU 312, the floating-point register file 313, the FX bus, the FY bus, and the FZ bus. The floating-point unit 307 receives a supply of instructions, i.e., the control signal that is obtained when the instruction is decoded by the instruction decoder 305, as well as the operand that is obtained by the operand processing circuit, from the FIFO 308, in the order that the instructions were queued therein. The floating-point ALU 312 executes the objective instruction according to the operation unit control signal that is supplied by the FIFO 308. In such a circumstance, the input operand(s) is/are supplied via at least one of the FX bus and the FY bus. The FZ bus is notified of the output operand, and the result of the operation of the floating-point ALU 312 is supplied to the floating-point register file 313, according to the output operand. The operation result may also be supplied to the memory 301 when the invention is applied to the CISC processor architecture.

It is also permissible for the processor 300 to comprise a plurality of integer units 306, or a plurality of floating-point units 307.

Per the foregoing configuration, the processor 300 is capable of separating the objective instructions, which require a comparatively large number of processing cycles to execute, from the non-objective instructions, which require a comparatively small number of processing cycles to execute, and execute the respective types of instructions in parallel.

Consequently, the processing speed of the processor is accelerated.

The processor 300 may have to stall processing in some circumstances, however, owing to a dependent relationship between data or resources, for example, such as data to be operated on that is generated by another instruction has not been fully prepared, i.e., operations thereon have not been completed. Following is a description of a configuration whereby the processor 300 controls stalling, as well as a configuration for accelerating processing by reducing the incidence of stall.

An example of a dependent relationship of data or resources might be such as an Address Generation Interlock (AGI), a data or flag dependent relationship, or a waiting of memory access or operation resources.

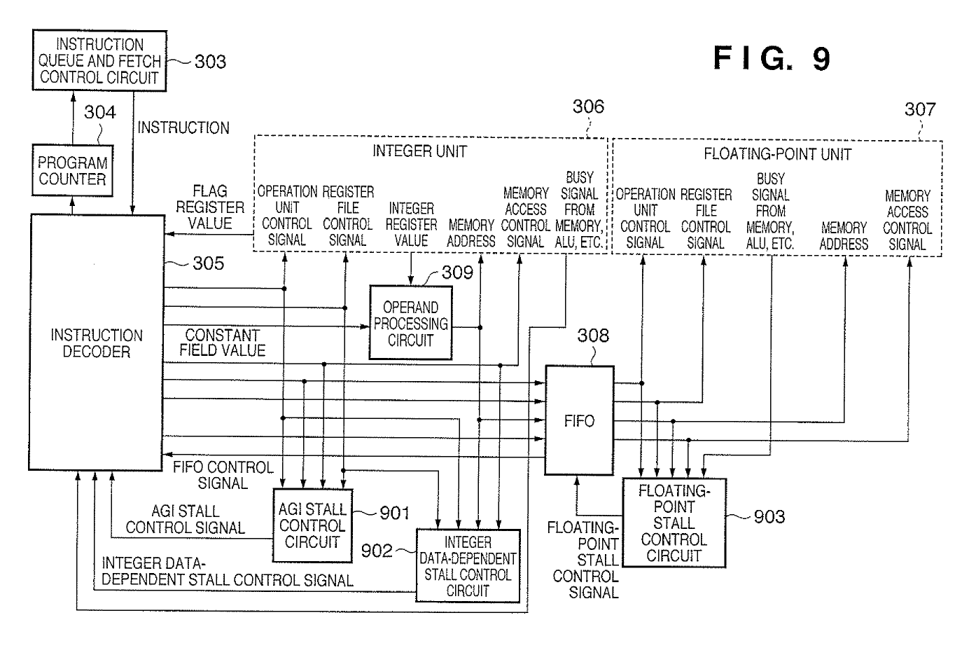

FIG. 9 depicts an example of a stall control configuration with regard to the processor 300. Configuration elements in FIG. 9 that are identical to configuration elements in FIG. 3 are labeled with the same reference numerals as in FIG. 3, and descriptions thereof are omitted.

The processor 300 comprises an AGI stall control circuit 901, an integer data dependency stall control circuit 902, and a floating-point stall control circuit 903.

AGI Stall Control:

For example, the series of two instructions in the assembly code depicted in FIG. 2 depict a dependent relationship in the register r3, and the operand processing circuit 309 must secure the value of the register r3 prior to processing the operand of the instruction (2), i.e., the result of executing the instruction (1) must be written back to the integer register file 311:

mov r3, #0 (1)

fmov fr0, @(r0+4*r3) (2)

If the pipeline latency of the integer unit 306 precludes securing the value of the register r3, the process must be interrupted. Consequently, the AGI stall control circuit 901 must come before the operand processing circuit 309. Determining whether or not the AGI stall is necessary depends on the integer register number, i.e., the “3” in “r3,” not the content of the register r3 itself.

Stall Control as a Consequence of a Data Generation Dependent Relationship:

Given a sequence of two instructions, i.e.:

fmov @(r0), fr1 (3)

fmov fr0, @(r2+4*r3) (4)

It is possible to detect whether or not the operands “@(r0)” and “@(r2+4*r3)” point to the same address only after the address of the operand is secured. A data generation dependent relationship stall control circuit must come after the operand processing circuit 309, i.e., corresponding to the integer data dependency stall control circuit 902.

When the floating-point unit 307 accesses the memory 301, it is not possible to know whether or not the memory 301 is busy until immediately prior to the floating-point unit 307 accessing the memory 301. For example, when calculating an error with the “fsqrt” instruction that is depicted in FIG. 4 (the error, in the present circumstance, refers to taking the input value from the square of the candidate operation result) and terminating the operation if the error is within a baseline value, it is not possible to know the number of cycles until the operation is terminated, because the number of cycles depends on the input value. In such a circumstance, it is necessary to use a busy signal from either the memory 301, the floating-point unit 307, or other units, to control the stall in the floating-point operation after the FIFO 308, corresponding to the floating-point stall control circuit 903. For example, the floating-point unit 307 supplies the busy signal to the floating-point stall control circuit 903 while executing the “fsqrt” instruction. The floating-point stall control circuit 903 responds to the busy signal by interrupting the floating-point unit 307′s receipt of the next instruction from the FIFO 308.

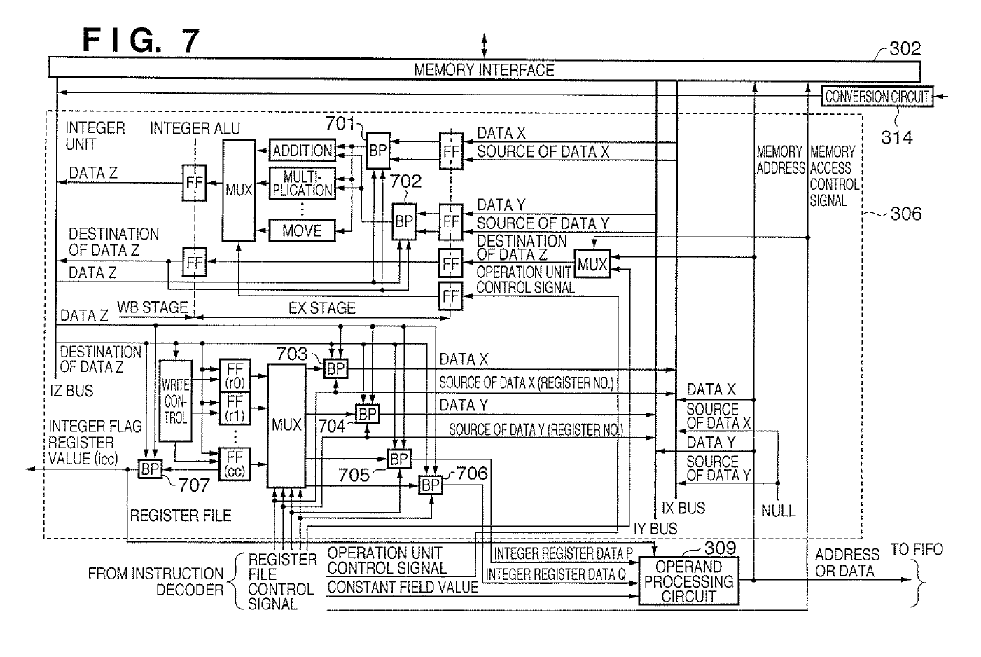

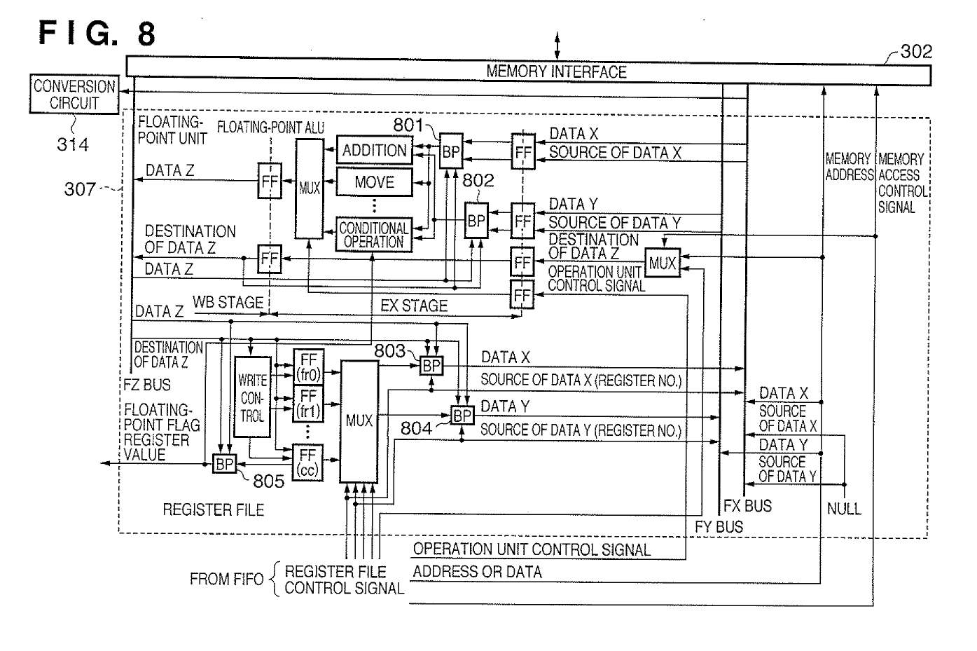

The processor 300 may comprise a pipeline or a bypass circuit (BP), such as depicted in FIG. 7 or FIG. 8. Configuration elements in FIG. 7 or FIG. 8 that are identical to configuration elements in FIG. 3 are labeled with the same reference numerals as in FIG. 3, and descriptions thereof are omitted.

Register Data Bypass Pertaining to Identical Type of Operations, with Reference to FIG. 8:

Take, for example, the following series of instructions, as depicted in the assembly code in FIG. 2:

fmov fr0, @(r0+4*r3) (A)

fmov fr1, @(r1+4*r3) (B)

fmul fr0, fr0, fr1 (C)

The result of the execution of the instruction (B) is used by the following instruction (C), one instruction later, and the result of the execution of the instruction (A) is also used by the following instruction (C), two instructions later. It is presumed that the respective results of the execution of the instruction (A) and the instruction (B) are each respectively supplied at the floating-point ALU 312, by way of the memory interface 302, to the FZ bus at the same latency, i.e., the same number of cycles. When the instruction (C) selects the content of the registers fr0 and fr1 of the floating-point register file 313, the storage of the results of the execution of the instruction (A) and the instruction (B) into the floating-point register file 313 is not finished. The result of the execution of the instruction (A) is supplied in place of the value of the register fr0, by way of a bypass circuit 803, and the result of the execution of the instruction (B) is supplied directly to an execution (EX) stage, by way of a bypass circuit 802, thus facilitating the execution of the instruction (C), without waiting for the results of the execution being written back to the floating-point register file 313. As a bypass condition, a comparison is performed of a destination and a source of data, and the data is supplied via the bypass circuit if a match results.

Address Generation Bypass, with Reference to FIG. 7:

Take, for example, the following two-instruction sequence, as depicted in the assembly code in FIG. 2:

mov r3, #0 (D)

fmov fr0, @(r0+4*r3) (A)

The result of the execution of the instruction (D) is used in calculating the address of the operand of the instruction (A), which must wait two processing cycles for the result of the execution of the instruction (A) written back to the integer register file 311. Supplying the result of the execution of the instruction (D) via the bypass circuit 706, in place of the value from the integer register file 311, shortens the latency of the instruction (A) to one processor cycle.

Memory Bypass:

Take, for example, the following two-instruction sequence:

fmov @(r0), fr1 (E)

fmov fr2, @(r2+4*r3) (F)

If the operands “@(r0)” and “@(r2+4*r3)” point to the same memory address, the instruction (E) and the instruction (F) have a dependent relationship, which does not exist if they point to different memory addresses. Consequently, it is necessary either to bypass, or control the stall, in response to the operand processing result. The bypass circuit in such a circumstance may be implemented within the memory interface 302, similar to the depiction of the bypass circuit in FIG. 7 and FIG. 8.

Flag Value Bypass:

As with the data, it is possible to shorten or eliminate the latency of the instruction that uses the flag, by building either a bypass circuit 707 or a bypass circuit 805 for the value of the flag register, either icc or fcc.

When a Value is Loaded into the ALU via the Operand Processing Circuit 309, with Reference to FIG. 7:

Take, for example, the following two-instruction sequence:

mov r3, #0 (G)

mov r2, r0+4*r3 (H)

The result of the execution of the instruction (G) is used to calculate the operand of the instruction (H). Although the register r3, which contains the result of the execution of the instruction (G), is within the operand of the instruction (H), “r0+4*r3”, the result of the instruction (G) must not be supplied to the instruction (H) via a bypass circuit 701. If the bypass circuit 701 were used, the operand of the instruction (H), “r0+4*r3”, would be replaced with the value of r3. In such a circumstance, the shortest latency results from delaying the commencement of the execution of the instruction (H) by one processing cycle, and using the bypass circuit 706 within the integer register file 311 to supply the result of the execution of the instruction (G) to the operand processing circuit 309.

Take, for example, an instruction such as the following:

fmov fr3, #0×1000 (I)

The instruction, which loads a constant, has no dependent relationship, no matter what instruction may lie therebefore.

Implementing above-described bypass controlling, regarding a signal that is supplied to any of IX, IY, FX, or FY via the operand processing circuit 309, the operation of the bypass circuits 701, 702, 801, or 802 within the ALU is suspended by setting the origin of the signal to null, which is not associated with any origins.

The processor 300 may comprise a speculative execution function, which, when used, allows the processor 300 to cause a process to branch in accordance with a branch prediction, i.e., a prediction of a result of a calculation, and execute a post-branch instruction, without waiting for the completion of a calculation of the branch condition. The accuracy of the branch prediction is determined by the completion of the calculation of the branch condition. It is necessary to cancel the instruction that was executed by the speculative execution if the branch prediction is in error.

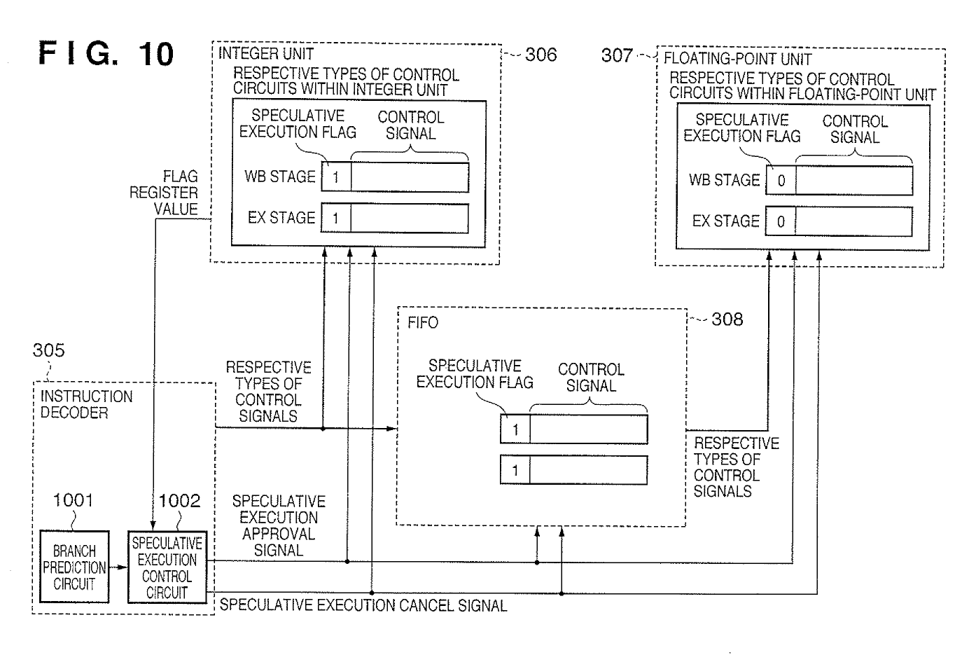

FIG. 10 is an example of a configuration wherein the speculative execution function has been added to the processor 300. Configuration elements in FIG. 10 that are identical to configuration elements in FIG. 3 are labeled with the same reference numerals as in FIG. 3, and descriptions thereof are omitted.

The instruction decoder 305 comprises a branch prediction circuit 1001 and a speculative execution control circuit 1002. If the decoded instruction is a conditional branch instruction, such as the “jle” instruction that is depicted in FIG. 4, the branch prediction circuit 1001 predicts the result of the calculation of the branch condition, and notifies the speculative execution control circuit 1002 thereof. The speculative execution control circuit 1002 sets a speculative execution flag, i.e., a speculative execution information, which denotes to the instruction that is being executed speculatively, or more precisely, to the decoded control signal, that the instruction is being executed speculatively. In FIG. 10, “1” signifies that the speculative execution flag is set, and “0” signifies that the speculative execution flag is either unset or cleared.

If the instruction is an objective instruction, it is queued in the FIFO 308, and thus, canceling the instruction must extend to the instruction that is queued therein. Since the number of instructions that are queued in the FIFO 308 fluctuates according to processing circumstances, it is not possible to uniquely determine a corresponding pipeline stage in accordance with the number of instructions to be canceled, i.e., the number of instructions from the point at which an error in the branch prediction is discovered are to be canceled. Hence, the speculative execution control circuit 1002 employs an approval signal and a cancel signal to perform control of an instruction that is speculatively issued. When it is determined that the branch prediction is correct, the speculative execution control circuit 1002 issues the approval signal for all instructions in the pipeline that are executed on the processor 300, and performs a clear on the speculative execution flag. When it is determined that the branch prediction is incorrect, however, the speculative execution control circuit 1002 issues the cancel signal for all instructions in the pipeline that are executed on the processor 300, and performs a delete on the instructions for which the speculative execution flag is set. Processing continues for the instructions for which the speculative execution flag is not set, i.e., such manipulation is not performed thereupon, even if either the approval signal or the cancel signal are issued. If neither the approval signal nor the cancel signal are issued, the control signal within the pipeline proceeds to the next stage of the pipeline, maintaining the existing state of the speculative execution flag. If the branch prediction is incorrect, and the speculative execution is canceled, the instruction decoder 305 returns to the branch instruction that was slated for prediction, and the branching is redone in accordance with the value of the flag register cc.

While the conditional branch instruction selects one path, or branch, from two possible branches according to the embodiment, the speculative execution that is described herein is also applicable to selecting one path from among three or more possible branches.

It is also presumed, according to the embodiment, that a nested speculative execution, i.e., a branch of a speculative execution within another speculative execution, is not performed. It would be possible, however, for the speculative execution control circuit 1002 to perform the approval and cancel control on the speculative execution, even when performing nested speculative execution, by extending the speculative execution flag to a plurality of bits.

It is also possible for the branch prediction to be executed in accordance with an arbitrary criterion, such as always choosing a specified branch, or choosing the same branch as was chosen at the most recent branch.

The flag, i.e., the value of the flag register, is generated by an operation performed by either the integer ALU 310 or the floating-point ALU 312, and is used by such as the conditional branch instruction “jle”, or an integer or floating-point conditional selection instruction “sel” or “fsel”; refer to FIG. 4 for details.

Since the objective and the non-objective instructions are executed in parallel as described above, a flag-driven dependent relationship may arise between an instruction that generates a flag and an instruction that uses a flag.

For example, if a flag that is generated by a non-objective instruction is used by an objective instruction, it becomes necessary for the flag to be propagated to the objective instruction with the relationship therebetween preserved. Conversely, if a flag that is generated by an objective instruction is used by a non-objective instruction, or by a control instruction that is executed by the instruction decoder 305, it becomes necessary for the non-objective instruction (or the control instruction) to wait for the execution of the objective instruction in the floating-point ALU 312, i.e., the generation of the flag. Following is a concrete description.

If a Flag that is Generated by a Non-objective Instruction is Used by an Objective Instruction:

Take, for example, an instruction that generates the value of the immediately previous integer flag register icc:

cmp r3, #0×10 (J)

Take also, for example, an instruction that selects either the register fr1 or the register fr2, and assigns the selected register to the register fr0, in accordance with the register icc:

fsel fr0, fr1, fr2 (K)

The instruction (K) may be depicted as an instruction with two operands, employing a function f, as follows:

fmov fr0, f(icc, fr1, fr2) (L)

Substituting the operand “f(icc, fr1, fr2)” for either the fr1 or the fr2 in the operand processing circuit 309, in accordance with the register icc, converts the instruction (L) into either:

fmov fr0, fr1 (M)

or:

fmov fr0, fr2 (N)

in a manner similar to memory access by the non-objective instruction. To be more precise, the instruction is decoded, in the instruction decoder 305, in the floating-point unit 307 control signal format. Consequently, the dependent relationship involving the register icc is resolved.

When the Flag that is Generated by the Objective Instruction is Used by Either the Non-Objective Instruction or the Control Instruction:

Propagating a flag that is generated by the objective instruction to either the non-objective instruction or the control instruction requires waiting for the processing of the floating-point unit 307. In such a circumstance, the instruction decoder 305 performs a synchronization process by interrupting the decoding of either the non-objective instruction or the control instruction.

Many physical operations are represented with differential, or contiguous and smooth, functions, resulting in few performances of branching based on physical quantity. For example, concerning to branching operations on physical data with regard to a WCDMA receiver, branching based on a floating-point comparison would be on the order of 1% of the total operations. Consequently, waiting for the floating-point unit 307 process does not have a significant impact on processing performance.

It would also be permissible for the instruction decoder 305 to perform speculative execution without waiting for the flag to be generated. Take, for example, an instruction that generates the most previous flag:

fcmp fr3, #0×10 (O)

Take also, for example, an instruction that selects either the register r1 or the register r2, and assigns the selected register to the register r1, in accordance with the register fcc:

sel r0, r1, r2 (P)

It is possible to speculatively select either r1 or r2 and assign the selected register to r0 without waiting for the floating-point unit 307 to generate the flag, for example, in accordance with such as the result of the previous operation. In such a circumstance, when the FIFO 308 is deeper than the pipeline length of the integer unit 306, the result of the speculative execution of the instruction (P) will be loaded in the register r0 prior to commencement of the instruction (O) as pertains to the floating-point unit 307. Canceling the speculative execution in such a circumstance necessitates saving the content of the register r0 prior to the speculative execution. It is thus possible to employ the speculative execution flag depicted in FIG. 10 to perform such control as saving the register r0 prior to the speculative execution.

Performing a conversion between a floating-point number and an integer necessitates processing in a manner similar to flag dependency. Converting the integer to the floating-point number necessitates propagation with the associated relationship maintained in the process. Conversely, converting the floating-point number to the integer necessitates waiting for the processing of the floating-point operation.

Conversion from Integer to Floating-Point Number:

It is possible to convert an integer register operand to a floating-point register operand in the operand processing circuit 309, in a manner similar to the propagation of the flag from the non-objective to the objective instruction.

Conversion from Floating-Point Number to Integer:

When the integer unit 306 directly uses the result of the conversion from the floating-point number to the integer, it is necessary to wait for the processing of the floating-point unit 307, in a manner similar to the propagation of the flag from the objective instruction to the conditional branch instruction or the non-objective instruction. In such a circumstance, performing synchronization processing in hardware and sending the conversion result from the floating-point unit 307 to the integer unit 306, with the conversion circuit 314 that is directly connected to the floating-point unit 307 and the integer unit 306, is desirable. It is also possible for the floating-point unit 307 to store the conversion result in memory when the conversion result is not going to be used immediately, and have the integer unit 306 read out the conversion result when required.

As described above, according to the embodiment, the program that the processor 300 executes contains the two types of instructions that are classified according to the property of data upon which the instruction is to operate. Typically, the two types of instructions are the objective instruction, the execution thereof demanding a comparatively large number of execution cycles, and the non-objective instruction, the execution thereof demanding a comparatively small number of execution cycles. The processor 300 comprises the instruction decoder 305 and the FIFO 308. The instruction decoder 305 supplies the objective instruction to the FIFO 308, and causes different operation units, for example, the floating-point unit 307 and the integer unit 306, to execute the objective instruction and the non-objective instruction, respectively. The floating-point unit 307 and the integer unit 306 respectively execute the objective instruction and the non-objective instruction in parallel. The configuration allows accelerated processing speed while keeping complexity in processor circuit configuration under control. It is thus possible to offer a faster processor while keeping control of such aspects as increases in the number of transistors and commensurate power consumption, increases in chip surface area, and rising costs.

Following is a description of a processor that is configured to be capable of executing a plurality of instructions in parallel, while keeping complexity in processor circuit configuration under control, by sharing operation resources, in particular, the floating-point ALU, according to an embodiment.

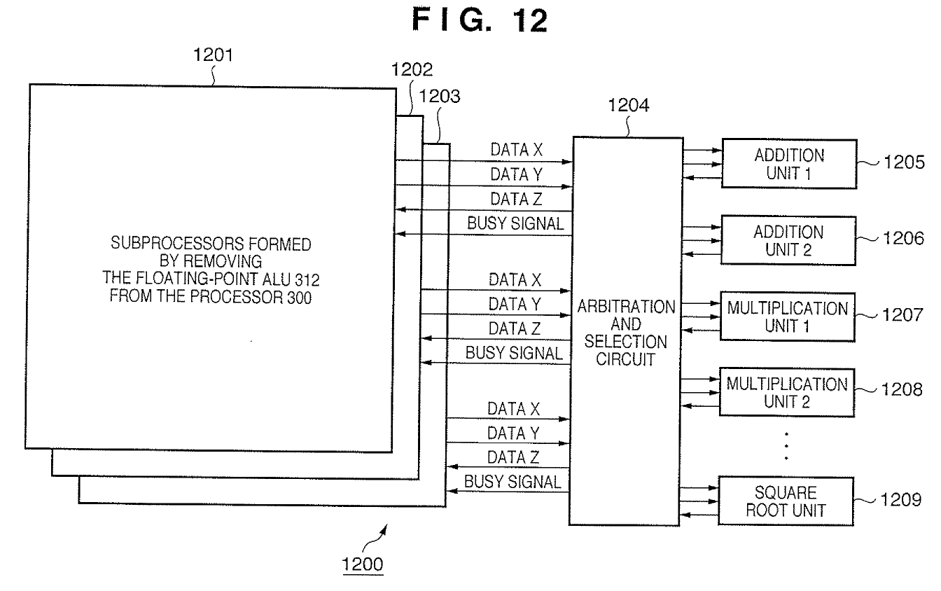

FIG. 12 is a block diagram depicting an example of a configuration of a processor 1200 according to a second embodiment. It is presumed that the processor 1200 comprises a plurality of subprocessors, reference numerals 1201, 1202, and 1203, each of which is the processor 300 according to the first embodiment, with the floating-point ALU 312 removed. The number of subprocessors is not limited to three. The processor 1200 shares the operation resource of the floating-point ALU. The processor 1200 comprises a variety of operation units as operation resources, such as an addition unit, a multiplication unit, and a square root unit, the simultaneous use thereof being comparatively rare. Sharing the operation resources across the plurality of subprocessors reduces the size of the circuit.

In FIG. 12, the processor 1200 comprises two addition units, reference numerals 1205 and 1206, two multiplication units, reference numerals 1207 and 1208, and one square root unit, reference numeral 1209, as operation resources. The processor 1200 also comprises an arbitration and selection circuit, reference numeral 1204. It is not necessary, however, for all blocks depicted in FIG. 3 or FIG. 12 to be built into a single structure in the processor 1200. It would be permissible, for example, for the memory 301 that is contained in the subprocessors 1201, 1202, and 1203 to be comprised in a separate chip from the processor 1200. It would also be permissible for the memory 301 to be shared among the plurality of subprocessors 1201, 1202, and 1203.

The operation resources are included in the processor 1200 according to the frequency of use of the type of operation, such as addition or multiplication. The example depicted in FIG. 12 includes two each of addition and multiplication units, and only one square root unit, which is not used very frequently. Each respective subprocessor 1201, 1202, and 1203 selects and uses the operation unit via the arbitration and selection circuit 1204, which functions as a control circuit, receiving the objective instructions in parallel from each respective FIFO 308 of the plurality of subprocessors, selecting the operation unit in accordance with the operation type according to the received instruction, and supplying the received instruction to the selected operation unit. If a conflict results in insufficient operation unit resources, a stall of the floating-point unit is performed. When a conventional processor is used as a subprocessor, performing the stall of the floating-point unit results in a stall of both the instruction decoder and the integer unit. When scheduling the out-of-order execution according to conventional technology, since the scheduling is performed in advance in the instruction decoder, it is difficult to schedule in response to external circumstances. In contrast, according to the embodiment, since the floating-point instruction is queued in each respective FIFO 308 of the subprocessors 1201, 1202, and 1203, even if a stall of the floating-point unit is performed the stall of the instruction decoder and the integer unit is avoided in many instances. As described above, according to the embodiment, the plurality of subprocessors of the processor 1200 shares the floating-point ALU. If a stall occurs in the floating-point unit, as a result of insufficient resources, the objective instructions are queued in the FIFO 308 that is contained within each respective subprocessor.

The configuration facilitates the parallel execution of a plurality of instructions, while keeping increased complexity of the processor circuit configuration under control. It also allows keeping stalls resulting from insufficient resources under control.

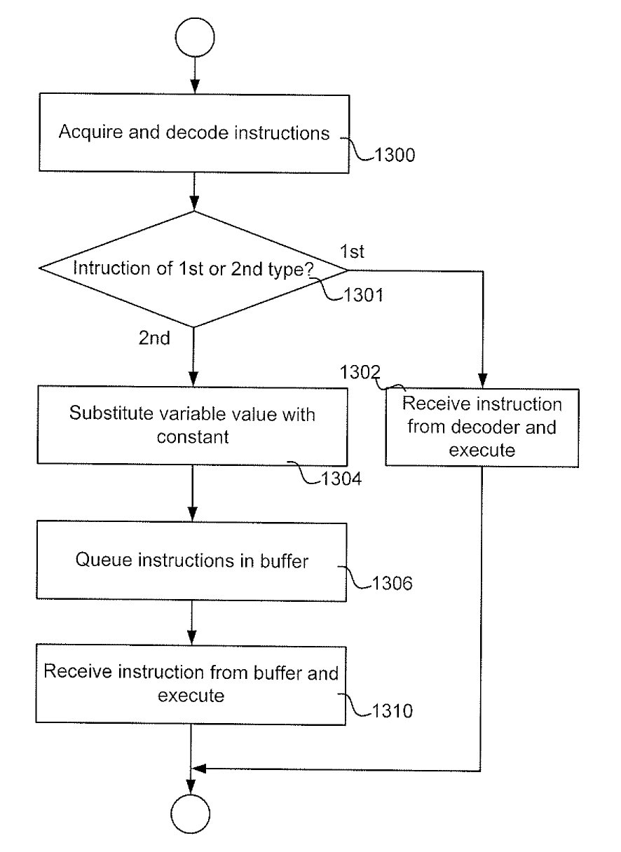

FIG. 13 is a flow chart illustrating a method according to an embodiment of the present invention. The method operates a processor 300 such that instructions are efficiently executed. The method comprises sequentially acquiring and decoding 1300 instructions from a program by a decoder 305, including an instruction of a first type and an instruction of a second type, which are classified 1301 according to a property of data upon which the instruction is to operate. The method further comprises sequentially receiving from the decoder 305, and executing the instruction 1302 of the first type by a first operation unit 306. The method further comprises substituting 1304 a variable value with a constant by an operand processing circuit 309, which variable value is set into a register 311 that is associated with the first operation unit 306, and which is included within an operand of the instruction of the second type. The method further comprises queuing 1306 in a buffer 308 the instruction of the second type that has been decoded by the decoder 305, and the operand thereof has been substituted by the operand processing circuit 309. The method also comprises sequentially receiving from the buffer 308, and executing the instruction 1310 of the second type by a second operation unit 307.

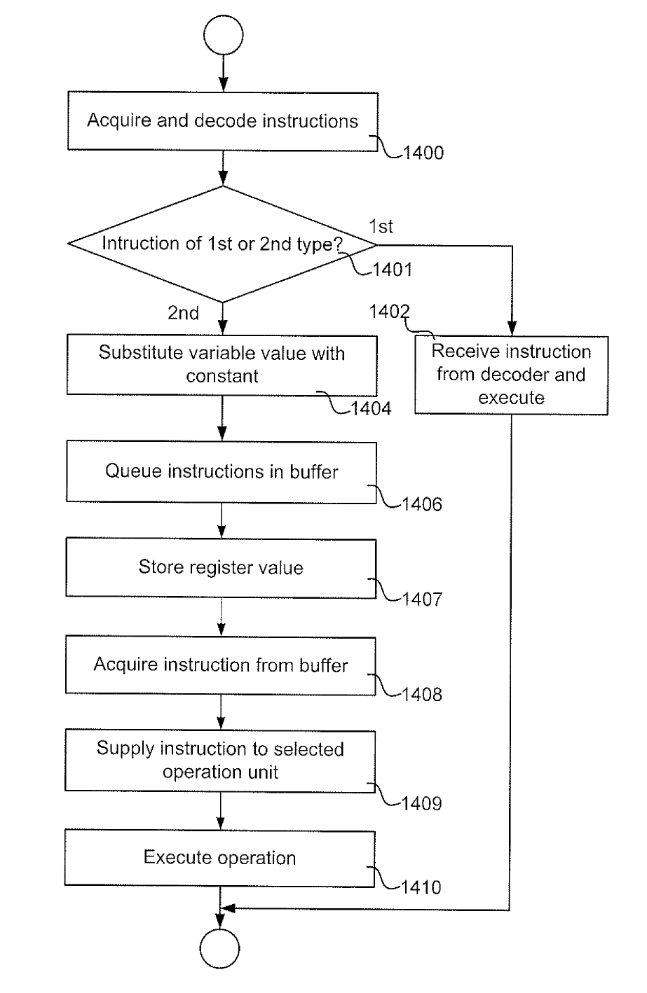

FIG. 14 is a flow chart illustrating a method according to an embodiment of the present invention. The method is intended for operating a processor 1200 comprising a plurality of subprocessors 1201, 1202, 1203, a plurality of operation units 1205-1209 and a control circuit 1204. The method comprises sequentially acquiring and decoding instructions 1400 from a program by a decoder 305 of at least one of the subprocessors 1201, 1202, 1203, the instructions including an instruction of a first type and an instruction of a second type which are classified 1401 according to a property of data upon which the instruction is to operate. The method further comprises sequentially receiving from the decoder 305, and executing the instruction 1402 of the first type by a first operation unit 306 of one of the subprocessors 1201, 1202, 1203. The method further comprises substituting 1404 a variable value with a constant, which variable value is set into a register 311 that is associated with the first operation unit 306, and which is included within an operand of the instruction of the second type by an operand processing circuit 309. The method also comprises queuing 1406 in a buffer 308 the instruction of the second type that has been decoded by the decoder 305, and the operand thereof has been substituted by the operand processing circuit 309. The method further comprises storing 1407 by a register file 313 a register value associated with the instruction of the second type. The method further comprises sequentially acquiring 1408 the instruction of the second type in parallel from each respective buffer 308 of the plurality of subprocessors 1201, 1202, 1203, and supplying 1409 the acquired instruction to an operation unit that is selected, from a plurality of operation units 1205-1209, in accordance with a type of operation that is executed by the acquired instruction by a control circuit 1204. The method also comprises executing 1410 the operation associated with the instruction of the second type by the selected operation unit of the plurality of operation units 1205-1209.

Any of the methods of the embodiments above can optionally comprise treating either an I/O data that is an object of the program, or a data of the I/O data that is being operated on, as a data for the instruction of second type to operate on by the instruction of the second type, and treating a data other than the I/O data or the data of the I/O data that is being operated on as a data for the instruction of the first type to operate on by the instruction of the first type. Further optionally, the methods can comprise treating a floating-point data as a data for the instruction of the second type to operate on by the instruction of the second type, and treating an integer data as a data for the instruction of the first type to operate on by the instruction of the first type. Each first operation unit 306 can include an integer arithmetic and logic unit 310, and each second operation unit 307, 1205-1209 can include a floating-point arithmetic and logic unit 312 or share one floating-point arithmetic and logic unit. Any of the methods can further comprise controlling a speculative execution in accordance with a branch prediction a speculative execution control circuit 1002 of the decoder 305, attaching a speculative execution information that denotes that speculative execution has taken place, by the speculative execution control circuit 1002, to an instruction that is speculatively executed, controlling the first operation unit 306, the second operation unit 307, 1205-1209, and the buffer 308 by the speculative execution control circuit 1002, such that the speculative execution information is cleared from the instruction to which the speculative instruction information is attached, if it is determined that the branch prediction is correct, and controlling the first operation unit 306, the second operation unit 307, 1205-1209, and the buffer 308 by the speculative execution control circuit 1002, such that the instruction to which the speculative execution information is attached is cancelled, if it is determined that the branch prediction is incorrect. Any of the methods can also comprise interrupting receipt of the instruction of the second type by the second operation unit 307, 1205-1209 to execute the instruction of the second type, in response to a signal that is supplied by this second operation unit 307, 1205-1209, said signal denoting that this second operation unit 307, 1205-1209 is in the process of executing another instruction of the second type.

The method of controlling the processor can be implemented by a computer program comprising instructions, which when executed by a processor causes the processor to perform the method according to any of the embodiments demonstrated above. The computer program can be a part of an operating system, firmware, or other hardware interfacing software. The computer program can be stored on a computer readable medium.

1.-15. (canceled)

16. A processor, comprising:
a decoder which sequentially acquires and decodes instructions from a program, including an instruction of a first type and an instruction of a second type, which are classified according to a property of data upon which the instruction is to operate;
a first operation unit which sequentially receives from the decoder, and executes, the instruction of the first type;
an operand processing circuit which substitutes a variable value with a constant, which variable value is set into a register that is associated with the first operation unit, and which is included within an operand of the instruction of the second type;
a buffer which queues the instruction of the second type that has been decoded by the decoder, and the operand thereof has been substituted by the operand processing circuit; and
a second operation unit which asynchronously with the first operation unit and sequentially receives from the buffer, and executes, the instruction of the second type such that the respective types of instructions are executable in parallel irrespective of the number of processing cycles required for the respective types of instructions.

17. A processor, comprising:
a plurality of subprocessors, each subprocessor comprising a processor as defined by claim 16, and a register file which stores a register value associated with the instruction of the second type;
a plurality of second operation units which execute an operation associated with the instruction of the second type; and
a control circuit which sequentially acquires the instruction of the second type in parallel from each respective buffer of the plurality of subprocessors, and supplies the acquired instruction to the second operation unit that is selected, from the plurality of second operation units, in accordance with a type of operation that is executed by the acquired instruction.

18. The processor of claim 16, wherein the instruction of the second type treats either an I/O data that is an object of the program, or a data of the I/O data that is being operated on, as a data for the instruction of second type to operate on; and
the instruction of the first type treats a data other than the I/O data or the data of the I/O data that is being operated on as a data for the instruction of the first type to operate on.

19. The processor of claim 16, wherein the instruction of the second type treats a floating-point data as a data for the instruction of the second type to operate on; and
the instruction of the first type treats an integer data as a data for the instruction of the first type to operate on.

20. The processor of claim 16, wherein the first operation unit includes an integer arithmetic and logic unit; and
the second operation unit includes a floating-point arithmetic and logic unit.

21. The processor of claim 16, wherein the decoder comprises a speculative execution control circuit which controls a speculative execution in accordance with a branch prediction; and
the speculative execution control circuit attaches a speculative execution information that denotes that speculative execution has taken place to an instruction that is speculatively executed; controls the first operation unit, the second operation unit, and the buffer, such that the speculative execution information is cleared from the instruction to which the speculative instruction information is attached, if it is determined that the branch prediction is correct; and controls the first operation unit, the second operation unit, and the buffer, such that the instruction to which the speculative execution information is attached is cancelled, if it is determined that the branch prediction is incorrect.

22. The processor of claim 16, further comprising a stall control circuit which interrupts receipt of the instruction of the second type by the second operation unit to execute the instruction of the second type, in response to a signal that is supplied by this second operation unit, the signal denoting that this second operation unit is in the process of executing another instruction of the second type.

23. A method of operating a processor, comprising:
sequentially acquiring and decoding instructions from a program by a decoder, including an instruction of a first type and an instruction of a second type, which are classified according to a property of data upon which the instruction is to operate;
sequentially receiving, from the decoder, and executing the instruction of the first type by a first operation unit;
substituting a variable value with a constant by an operand processing circuit, which variable value is set into a register that is associated with the first operation unit, and which is included within an operand of the instruction of the second type;
queuing in a buffer the instruction of the second type that has been decoded by the decoder, and the operand thereof has been substituted by the operand processing circuit; and
asynchronously with the first operation unit and sequentially receiving from the buffer, and executing the instruction of the second type by a second operation unit such that the respective types of instructions are executable in parallel irrespective of the number of processing cycles required for the respective types of instructions.

24. The method of claim 23, wherein the processor comprises a plurality of subprocessors, a plurality of operation units, and a control circuit;
acquiring and decoding instructions is performed by at least one of the subprocessors;
receiving and executing the instructions of the first type is performed by one of the subprocessors;
including within an operand of the instruction of the second type is performed by an operand processing circuit;
the method further comprises storing by a register file a register value associated with the instruction of the second type; and
receiving and executing the instruction of the second type comprises sequentially acquiring the instruction of the second type in parallel from each respective buffer of the plurality of subprocessors; supplying the acquired instruction to an operation unit that is selected, from a plurality of operation units, in accordance with a type of operation that is executed by the acquired instruction by a control circuit; and executing the operation associated with the instruction of the second type by the selected operation unit of the plurality of operation units.

25. The method of claim 23, further comprising treating either an I/O data that is an object of the program, or a data of the I/O data that is being operated on, as a data for the instruction of the second type to operate on by the instruction of the second type; and treating a data other than the I/O data or the data of the I/O data that is being operated on as a data for the instruction of the first type to operate on by the instruction of the first type.

26. The method of claim 23, further comprising treating a floating-point data as a data for the instruction of the second type to operate on by the instruction of the second type; and treating an integer data as a data for the instruction of the first type to operate on by the instruction of the first type.

27. The method of claim 23, wherein the first operation unit includes an integer arithmetic and logic unit; and the second operation unit includes a floating-point arithmetic and logic unit.

28. The method of claim 23, further comprising:
controlling a speculative execution in accordance with a branch prediction a speculative execution control circuit of the decoder;
attaching a speculative execution information that denotes that speculative execution has taken place, by the speculative execution control circuit, to an instruction that is speculatively executed;
controlling the first operation unit, the second operation unit, and the buffer by the speculative execution control circuit, such that the speculative execution information is cleared from the instruction to which the speculative instruction information is attached, if it is determined that the branch prediction is correct; and
controlling the first operation unit, the second operation unit, and the buffer by the speculative execution control circuit, such that the instruction to which the speculative execution information is attached is cancelled, if it is determined that the branch prediction is incorrect.

29. The method of claim 23, further comprising interrupting receipt of the instruction of the second type by the second operation unit to execute the instruction of the second type, in response to a signal that is supplied by this second operation unit, the signal denoting that this second operation unit is in the process of executing another instruction of the second type.

30. A computer-readable medium having stored instructions that, when executed by a computer, cause the computer to carry out a method of operating a processor, wherein the method comprises:
sequentially acquiring and decoding instructions from a program by a decoder, including an instruction of a first type and an instruction of a second type, which are classified according to a property of data upon which the instruction is to operate;
sequentially receiving, from the decoder, and executing the instruction of the first type by a first operation unit;
substituting a variable value with a constant by an operand processing circuit, which variable value is set into a register that is associated with the first operation unit, and which is included within an operand of the instruction of the second type;
queuing in a buffer the instruction of the second type that has been decoded by the decoder, and the operand thereof has been substituted by the operand processing circuit; and
asynchronously with the first operation unit and sequentially receiving from the buffer, and executing the instruction of the second type by a second operation unit such that the respective types of instructions are executable in parallel irrespective of the number of processing cycles required for the respective types of instructions.

31. The medium of claim 30, wherein the method further comprises treating either an I/O data that is an object of the program, or a data of the I/O data that is being operated on, as a data for the instruction of the second type to operate on by the instruction of the second type; and treating a data other than the I/O data or the data of the I/O data that is being operated on as a data for the instruction of the first type to operate on by the instruction of the first type.

32. The medium of claim 30, wherein the method further comprises treating a floating-point data as a data for the instruction of the second type to operate on by the instruction of the second type; and treating an integer data as a data for the instruction of the first type to operate on by the instruction of the first type.

33. The medium of claim 30, wherein the first operation unit includes an integer arithmetic and logic unit; and the second operation unit includes a floating-point arithmetic and logic unit.

34. The medium of claim 30, wherein the method further comprises:
controlling a speculative execution in accordance with a branch prediction a speculative execution control circuit of the decoder;
attaching a speculative execution information that denotes that speculative execution has taken place, by the speculative execution control circuit, to an instruction that is speculatively executed;
controlling the first operation unit, the second operation unit, and the buffer by the speculative execution control circuit, such that the speculative execution information is cleared from the instruction to which the speculative instruction information is attached, if it is determined that the branch prediction is correct; and
controlling the first operation unit, the second operation unit, and the buffer by the speculative execution control circuit, such that the instruction to which the speculative execution information is attached is cancelled, if it is determined that the branch prediction is incorrect.

35. The medium of claim 30, wherein the method further comprises interrupting receipt of the instruction of the second type by the second operation unit to execute the instruction of the second type, in response to a signal that is supplied by this second operation unit, the signal denoting that this second operation unit is in the process of executing another instruction of the second type.
